(19) United States
(12) Patent Application Publication
(10) Pub. No.: US 2010/0068913 A1
(43) Pub. Date: Mar. 18, 2010

(54) Coupler for holding a socket and plug of two electrical cords together

(76) Inventor: Richard A. Edge, Christiansted, VI (US)

Correspondence Address: RICHARD L. MILLER, 12 PARKSIDE DRIVE, DIX HILLS, NY, 11746, US

(21) Appl. No.: 12/283,580

(22) Filed: Sep. 12, 2008

(51) Int. Cl. H01R 13/62

(52) U.S. Cl. 439/369

(57) ABSTRACT

A coupler for holding a socket and plug of two electrical cords together which comprises a body fabricated out of a resilient material having a central cavity with two end bores. Each of the end bores extends from an opposite side of the body into the central cavity. An longitudinal axial slit extends along the body, wherein when the body is twisted the longitudinal axial slit will open to allow the socket and plug connected together to be inserted into the central cavity of the body with each of the two electrical cords extending outwardly from each of the two end bores of the body. The socket and plug of the two electrical cords will be maintain in intimate contact with each other within the central cavity of the body.

### BACKGROUND OF THE INVENTION

1. Field of the Invention

The present invention relates to an extension cord connector and more particularly, a coupler for holding a socket and plug of two electrical cords together.

2. Description of the Prior Art

Numerous innovations for socket and plug holders for electrical extension cords have been provided in the prior art that will be described. Even though these innovations may be suitable for the specific individual purposes to which they address, however, they differ from the present invention.

A FIRST EXAMPLE, U.S. Pat. No. 3,014,194, Issued on Dec. 19, 1961, to Berglund teaches a cable connector protector comprising an elongated tubular body having a chamber intermediate its ends to receive engaged cable connector plugs, the body having end portions formed with axial blind bores smaller in diameter than the chamber for receiving cable sections related to the connector plugs, the blind bores being tapered longitudinally outwardly, opposed longitudinally slideable wedges engaged with opposed sides of the bores to receive and frictionally engage cable sections therebetween, the wedges being longitudinally outwardly tapered to wedge against opposite sides of cable sections upon longitudinally outward movements of the cable sections relative to the body accompanied by the wedges, and means providing access to the chamber and the bores, the body being flexible and having a radial slit extending the length of the body and reaching inwardly to the chamber and the bores and defining body sections at opposite sides of the slit, and a longitudinally-elongated flexible slide bridging the slit and releasably engageable with means provided on the body section.

A SECOND EXAMPLE, U.S. Pat. No. 4,143,934, Issued on Mar. 13, 1979, to Siebert teaches a holder for retaining an electrical connection between two electrical power cords that includes a hinged housing defining two openings for the cords. A flexible jaw member is integrally molded on the housing adjacent each of the openings and opposite an integrally molded rigid jaw member, and an eccentric member is pivotally mounted adjacent each jaw member. When the cam members are manually rotated, the flexible jaw members are thereby flexed to clamp the cords against the rigid jaw members.

A THIRD EXAMPLE, U.S. Pat. No. 4,145,105, Issued on Mar. 20, 1979, to Dobson teaches a device for preventing the accidental disconnection of electrical cords comprising a first section and a second section. The first section has a conical-shaped plug receptacle adapted to receive any of a plurality of different sized, commercially available electrical plugs and a detent slot for holding the cord affixed to the plug. The second section has a detent slot adapted to receive a second electrical cord having a mating plug thereon. An adjustable means connects the first and second sections together to thereby prevent the accidental disconnection of the plugs when they are in a mated position.

A FOURTH EXAMPLE, U.S. Pat. No. 4,643,505, Issued on Feb. 17, 1987, to House et al. teaches a housing for maintaining the plugs of a pair of extension cords connected. The housing includes first and second members which are connected by a hinge along one edge. The interior surfaces of each of the first and second members include a series of grooves distributed along the length of the members. Retaining washers are designed to be engageable with the grooves to hold the plugs of a connected pair of extension cords in engagement. The provision of a series of grooves permits the housing to be adapted for use with a wide range of plug lengths. The slots in the retaining washers are designed so that the cable passing therethrough is slightly offset from the central axis to resist motion in the plugs. After the retaining washers have been positioned in the first and second members, the first and second members are pivoted about the hinge into abutting relationship and maintained therein by flexible hooks to form a capsule having a streamlined shape which resists entanglement in obstructions during use.

A FIFTH EXAMPLE, U.S. Pat. No. D296,779, Issued on Jul. 19, 1988, to Watson teaches an ornamental design for a cover cap for an extension cord, as shown.

A SIXTH EXAMPLE, U.S. Pat. No. 4,869,683, Issued on Sep. 26, 1989, to Nelson teaches a device for protectively enclosing coupled terminals of mated industrial gauge electrical cords. The device, which can accommodate terminals and cords of varying size, easily creates a water-impervious shield encompassing the coupled terminals. The device is comprised of a flexible sheath having two longitudinal edges interengageable by a zipper to form a tubular structure. Binding straps disposed upon the exterior surface of the sheath adjacent each tubular extremity apply compressive force to underlying sealing bands which grip the electrical cord.

A SEVENTH EXAMPLE, U.S. Pat. No. 5,584,720, Issued on Dec. 17, 1996, to Elswick teaches an electrical cord plug lock for securing plugs of a pair of electrical cords together. The inventive device includes a first cord clamp securable to an extension cord proximal to a plug thereof, and a second cord clamp securable to a power tool cord proximal to a plug of the power tool cord. A joining assembly extends between the cord clamps for securing the plugs together to preclude separation of the plugs during tensioning of the cords.

AN EIGHTH EXAMPLE, U.S. Pat. No. 6,080,004, Issued on Jun. 27, 2000, to Kovacik et al. teaches an electrical connection comprised of a pair of cooperating separable plug members having a separable locking yoke having legs the ends of which are pivotally mounted to boss members formed on one of the plug members and a pair of cooperating spaced apart elements for frictionally engaging the electrical conduit leading away from the other of the plug members.

A NINTH EXAMPLE, U.S. Patent Office Publication No. 2005/0079751, Published on Apr. 14, 2005, to Decker teaches a power cord plug and jack retainer that includes first and second mating sections. The first and second sections are adapted to mate such that the first section is female and the second section is male. The sections are provided with rhombic shaped pins and slots which lock in place against resilient forces provided by resilient pads and resilient straps. The retainer is provided with conical end portions to prevent snagging but is provided with hooks on the jack side of the conical portion for hooking the retainer on a suitable support such as a belt, ladder, branch or any other suitable support. The second section with the hooks on the conical portion may be used to hang a cord of a power tool or any other item having a cord with an enlarged portion. Any tool may be hung by a rope by placing a knot in the rope and hanging it from the second section.

A TENTH EXAMPLE, U.S. Pat. No. 6,997,734, Issued on Feb. 14, 2006. to McQuirter teaches a device for holding the plugs of power tool cords and extension cords in electric contact having a C-shaped collar on each end of a rigid rod. Attached to each collar is a flexible band with a complementary strip of separable adhesive material. When power tool cords and extension cords are plugged together and when the cords are placed in the collars, the collars abut the plugs. Wrapping the bands around their respective collars and pressing the adhesive strips together secures the cords in the collars. If a cord is jerked, the plugs will not lose electric contact, rather, the plugs will remain in contact and will move as a unit with this retention device.

AN ELEVENTH EXAMPLE, U.S. Pat. No. 7,001,202, Issued on Feb. 21, 2006, to Robbins teaches a retaining device that retains a pair of electrical power cords, one cord having a plug which is joined to a socket of the other cord. The device has first and second receptacles, each with a first open end and a second open end, and an opening extending from the first open end to the second open end. The first open end, the second open end, and the opening extending from the first open end to the second open end of the first and second receptacles together form a space for receiving the ends of the power cords, including the plug and socket. The first receptacle inserts into the second receptacle to adjust the overall length of the retaining device and locks in place to retain the ends of the pair of power cords and the plug and socket coupled to each other. The first receptacle is turned to release it from the second receptacle in order to remove the coupled ends of the power cords.

It is apparent now that numerous innovations for socket and plug holders for electrical extension cords have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a coupler for holding a socket and plug of two electrical cords together that avoids the disadvantages of the prior art.

ANOTHER OBJECT of the present invention is to provide a coupler for holding a socket and plug of two electrical cords together that is simple and inexpensive to manufacture.

STILL ANOTHER OBJECT of the present invention is to provide a coupler for holding a socket and plug of two electrical cords together that is simple to use.

BRIEFLY STATED, STILL YET ANOTHER OBJECT of the present invention is to provide a coupler for holding a socket and plug of two electrical cords together which comprises a body fabricated out of a resilient material having a central cavity with two end bores. Each of the end bores extends from an opposite side of the body into the central cavity. An longitudinal axial slit extends along the body,, wherein when the body is twisted the longitudinal axial slit will open to allow the socket and plug connected together to be inserted into the central cavity of the body with each of the two electrical cords extending outwardly from each of the two end bores of the body. The socket and plug of the two electrical cords will be maintain in intimate contact with each other within the central cavity of the body.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a diagrammatic perspective view of an embodiment of the present invention in use;

FIG. 2 is an enlarged diagrammatic perspective view of the circled area indicated by arrow 2 in FIG. 1;

FIG. 3 is an exploded diagrammatic perspective view similar to FIG. 2, showing the electrical cords being either inserted or removed therefrom;

FIG. 4 is an enlarged diagrammatic perspective view similar to FIG. 2 of the present invention per se;

FIG. 5 is a diagrammatic side elevational view of the present invention taken in the direction of arrow 5 in FIG. 4;

FIG. 6 is a diagrammatic end elevational view taken in the direction of arrow 6 in FIG. 5;

FIG. 7 is a diagrammatic cross-sectional view taken on line 7-7 of FIG. 6; and

FIG. 8 is a diagrammatic cross-sectional view taken on line 8-8 of FIG. 5.

### A MARSHALING OF REFERENCE NUMERALS UTILIZED IN THE DRAWING

10 coupler
12 socket
14 plug
16 first electrical cord
18 second electrical cord
20 body of coupler 10
22 resilient material of body 20
24 central cavity of body 20
26 first end bore of body 20
28 second end bore of body 20
30 longitudinal axial slit in body 20
32 oval football-shaped capsule type member for body 20
34 medium soft rubber for resilient material 22
36 bright color composition of body 20

### DETAILED DESCRIPTION OF THE PREFERRED EMBODIMENT

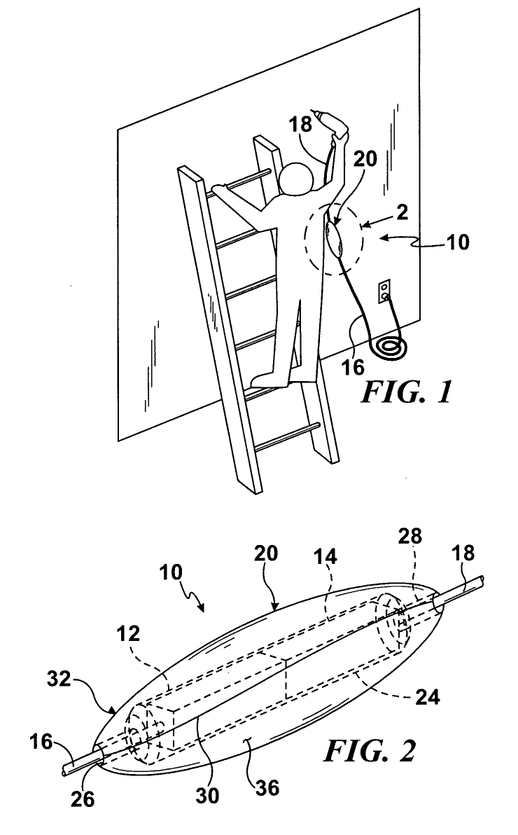

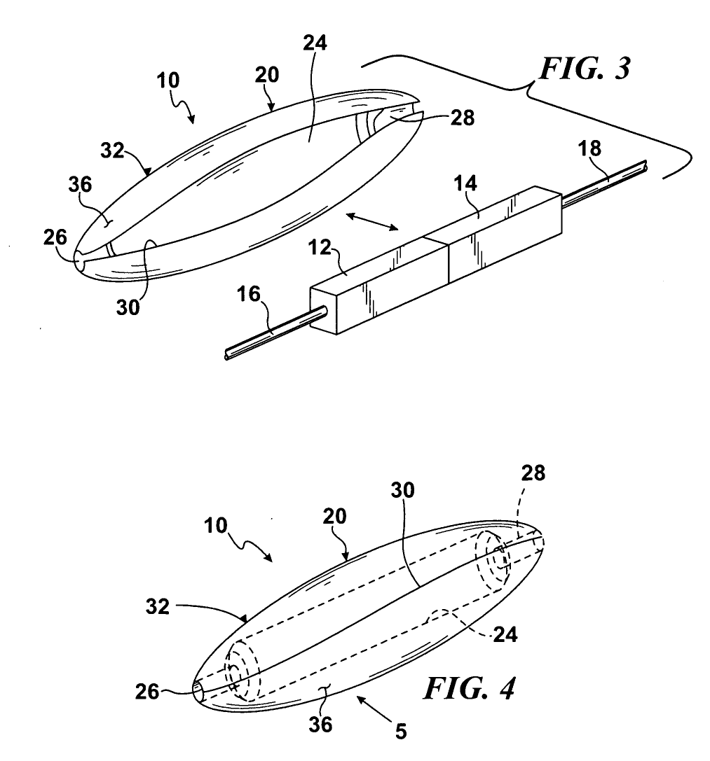

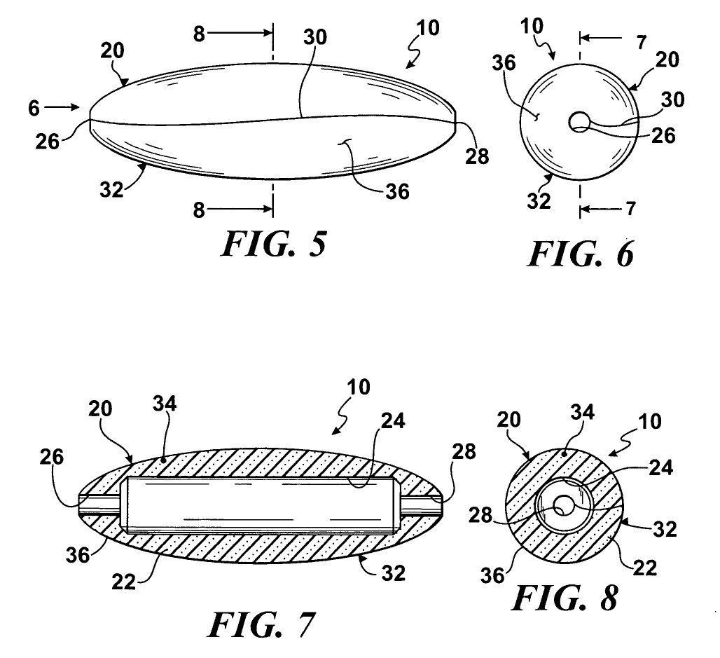

Referring now to the figures, in which like numerals indicate like parts, and particularly to FIGS. 1 through 8, which are a diagrammatic perspective view of an embodiment of the present invention in use; an enlarged diagrammatic perspective view of the circled area indicated by arrow 2 in FIG. 1; an exploded diagrammatic perspective view similar to FIG. 2, showing the electrical cords being either inserted or removed therefrom; an enlarged diagrammatic perspective view similar to FIG. 2 of the present invention per se; a diagrammatic side elevational view of the present invention taken in the direction of arrow 5 in FIG. 4; a diagrammatic end elevational view taken in the direction of arrow 6 in FIG. 5; a, diagrammatic cross-sectional view taken on line 7-7 of FIG. 6; and a diagrammatic cross-sectional view taken on line 8-8 of FIG. 5, and as such, will be discussed with reference thereto.

The present invention is a coupler 10 for holding a socket 12 and plug 14 of two electrical cords 16, 18 together which comprises a body 20 fabricated out of a resilient material 22 having a central cavity 24 with two end bores 26, 28. Each of the end bores 26, 28 extends from an opposite side of the body 20 into the central cavity 24. A longitudinal axial slit 30 extends along the body 20, wherein when the body 20 is twisted the longitudinal axial slit 30 will open to allow the socket 12 and plug 14 connected together to be inserted into the central cavity 24 with each of the two electrical cords 16, 18 extending outwardly from each of the two end bores 26, 28 of the body 20, whereby the socket 12 and plug 14 of the two electrical cords 16, 18 will be maintained in intimate contact with each other within the central cavity 24 of the body 20.

The body 20 comprises an oval football-shaped capsule type member 32. The resilient material 22 of the body 20 comprises a medium soft rubber 34. The resilient material 22 of the body 20 comprises a bright color composition 36, so as to be easily visible.

The two electrical cords 16, 18 can be two extension cords, one extension cord and one power tool cord (as shown in FIG. 1), or one extension cord and an electrical cord from an electrical appliance, such as a computer, television set, radio, electrical clock or any other electrical equipment that utilizes an electrical cord.

It will be understood that each of the elements described above, or two or more together, may also find a useful application in other types of constructions differing from the types described above.

While the invention has been illustrated and described as embodiments of a coupler for holding a socket and plug of two electrical cords together, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

1. A coupler for holding a socket and plug of two electrical cords together, which comprises:
a body fabricated out of a resilient material having a central cavity with two end bores;
wherein each bore of said end bores extending from an opposite side of said body into said central cavity, and a longitudinal axial slit extending along said body; and
wherein when said body is twisted, said longitudinal axial slit opens to allow the socket and plug connected together to be inserted into said central cavity of said body, with each of the two electrical cords extending outwardly from each of said two end bores of said body, respectively, whereby the socket and plug of the two electrical cords are maintained in intimate contact with each other within said central cavity of said body.

2. The coupler as recited in claim 1, wherein said body comprises an oval football-shaped capsule type member.

3. The coupler as recited in claim 1, wherein said resilient material of said body comprises a medium soft rubber.

4. The coupler as recited in claim 1, wherein said resilient material of said body comprises a bright color composition, so as to be easily visible.
